(19) United States
(12) Patent Application Publication
(10) Pub. No.: US 2025/0173800 A1
(43) Pub. Date: May 29, 2025

(54) Minimal Cost Scheduling of Energy Systems

(71) Applicant: Homayoun Yousefi'zadeh, IRVINE, CA (US)

(72) Inventor: Homayoun Yousefi'zadeh, IRVINE, CA (US)

(21) Appl. No.: 17/935,092

(22) Filed: Sep. 24, 2022

(51) Int. Cl. G06Q 50/06; G05B 13/02; H02J 13/00

(52) U.S. Cl. CPC G06Q 50/06; G05B 13/024; H02J 13/0005

(57) ABSTRACT

Lowest cost usage scheduling of an energy system during a time interval of interest is achieved by utilizing two components of learning and optimization. First, a number of learning approaches including Linear Least Square Regression (LLSR), Auto Regressive Integrated Moving Average (ARIMA), and Multi-Layer Perceptron Deep Learning (MLPDL) are used to forecast energy production and storage of the energy producing components of a given group of energy components as a function of historical production data and weather data collected from weather and geo reports. Then, an optimization problem is formulated to create the optimal schedule of energy usage during time intervals of interests for the given group of energy components subject to scheduling and equipment constraints. Two alternative solutions, namely Simplex Branch and Bound (SBB) and Interior Point Branch and Bound (IPBB) are presented to solve the optimization problem. Accordingly, integrated iterative methods, programs, and systems are described aiming at minimizing the cost of energy consumption for the given group of energy components within time intervals of interest.

### FIELD OF THE INVENTION

The present invention relates to methods, programs, and systems for minimizing the total cost of energy consumption of a group of remotely controlled smart plugs, energy consuming components, and energy producing and storing components either connected to or isolated from a power grid over given time intervals of interest.

### BACKGROUND OF THE INVENTION

With the ever increasing demand on the US and global power grids along with the rapidly increasing cost of producing and consuming energy, it is imperative to devise new methods and systems that allow for efficient use of energy. One of the most important issues related to efficient use of energy is to balance the supply and demand during operating hours. A review of energy usage patterns reveals much higher demands for commercial business units during regular daily operation hours and much higher demands for residential units during evening hours. Accordingly, utility companies such as SCE and PG&E are moving away from existing tiered usage pricing models and switching to Time Of Use (TOU) usage pricing models. In TOU models, utility companies charge consumers according to time of use in an attempt to balance supply and demand. While commercial units are charged at higher rates during daily operation hours, residential units pay higher rates during evening hours.

Correspondingly, using energy outside peak hours helps balance supply and demand while reducing energy cost for both commercial and residential consumers. This invention presents systematic optimal scheduling algorithms and methods of energy usage that are equally applicable to both commercial and residential units. The algorithms are capable of accommodating a heterogeneous mix of energy consuming, energy producing, and energy storing components and flexible enough to cover different time interval durations and schedule time granularities as needed. Such algorithms control the schedules of energy usage by signaling a number of smart plugs that feed deployed energy consuming components. In presence of energy storing components such as batteries, such algorithms force the use of existing stored energy during high demand TOU hours while they exert the use of energy from the power grid during low demand TOU hours as needed. Consequently, both residential and commercial consumers are provided with an opportunity to minimize their cost of energy consumption according to optimal scheduling algorithms.

The acronym GEC standing for Group of Energy Components is used to reflect the plurality of components within the group of remotely controlled smart plugs, energy consuming components, energy capturing components, energy storing components, and support components connected to a power grid. The acronym EPCs standing for Energy Producing Components is used to indicate the plurality of energy capturing components within the group such as solar panels, wind turbines, hydraulic turbines, steam turbines, generators, and energy storing components such as batteries along with all supporting equipment. The acronym ECCs standing for Energy Consuming Components is used to indicate the plurality of energy consuming components within the group such as Electric Vehicles (EVs), industrial machinery such as Computer Numerical Control (CNC) machines, residential appliances such as washers, and any other energy consuming device.

### BRIEF SUMMARY OF THE INVENTION

The subject disclosure features a method that allows for minimizing the total cost of energy usage for a group of remotely controlled smart plugs, energy consuming components, and optionally energy producing and storing components connected to a power grid. When present, the method effectively predicts the energy storage capacity of energy producing components of the group. Utilizing the predicted energy amount, consumption specifications of energy consuming components, and published pricing associated with the time of use, the method creates an automated schedule resulting in the lowest cost of energy usage for a set of time intervals of interest.

In an embodiment, illustrated by FIG. 1, the GEC comprises a group of remotely controlled smart plugs, energy consuming components, and energy producing and storing components connected to a power grid over given time intervals of interest.

A further embodiment of the present invention comprises a Linear Least Square Regression (LLSR) machine learning technique that can be iteratively trained by measurement and forecast data collected from weather and geo reports to accurately predict the energy production and storage of the EPC of a given GEC.

A further embodiment of the present invention comprises an Auto Regressive Integrated Moving Average (ARIMA) machine learning structure that can be iteratively trained by measurement and forecast data collected from weather and geo reports to accurately predict the energy production and storage of the EPC of a given GEC.

A further embodiment of the present invention comprises a Multi-Layer Perceptron Deep Learning (MLPDL) structure that can be iteratively trained by measurement and forecast data collected from weather and geo reports to accurately predict the energy production and storage of the EPC of a given GEC.

A further embodiment of the present invention comprises a detailed formulation of an optimization problem with the objective of minimizing the cost of energy consumption of a GEC through optimal scheduling and subject to constraints associated with available smart plugs, charging stations, and available hours.

Additional embodiments of the present invention feature solving this optimization problem using two algorithmic alternatives, namely, Simplex Branch and Bound (SBB) and Interior Point Branch and Bound (IPBB).

In one preferred embodiment, SBB algorithm described in FIG. 4 provides an automatic iterative process to balance energy supply and demand of a given GEC by creating a daily, weekly, or monthly optimal schedule of consumption with a desired time granularity during all hours subject to the restrictions of usage.

In another preferred embodiment, IPBB algorithm described in FIG. 5 provides an automatic iterative process to balance energy supply and demand of a given GEC by creating a daily, weekly, or monthly optimal schedule of consumption with a desired time granularity during all hours subject to the restrictions of usage.

In an integrated embodiment illustrated by FIG. 6, the present invention features a method to minimize the total cost of energy consumption of a given GEC either connected to or isolated from a power grid over a daily, weekly, or monthly time interval. The method may comprise:
importing static information including time interval duration, schedule granularity, specifications of all group devices, per unit cost of energy charged by a utility operator operating said power grid either based on time of use or tier of use (101);
importing per component energy consumption information at least comprising usage power of energy consuming components within said time interval (102);
if present, importing per component energy generation information at least comprising per component energy storage capacity, and dynamic factors within said time interval affecting the rate of energy generation (102);
waiting for the expiration of a refresh timer at the beginning of said time interval (103);
importing dynamic forecast information hourly sun, cloud, temperature, wind, humidity, precipitation, UV index, and water pressure (104)
choosing a prediction algorithm (105) to predict stored energy (105);
if LLSR machine learning prediction algorithm is chosen, applying LLSR algorithm (106) to predict stored energy;
if ARIMA machine learning prediction algorithm is chosen, applying ARIMA algorithm (107) to predict stored energy;
if MLPDL prediction algorithm is chosen, applying MLPDL algorithm (108) to predict stored energy;
setting predicted stored energy made available for use during time interval (109);
applying optimization static inputs comprising imported time interval duration, schedule time granularity, component specifications, and dynamic inputs comprising predicted stored energy (110);
choosing an optimization algorithm (111);
if IPBB algorithm is chosen, applying IPBB algorithm to minimize the cost of energy usage as the result of scheduling the use of energy over consecutive time slots by the plurality of group components to effectively redistribute the time of use of energy leading to lowest cost energy strategy within said time interval (112);
if SBB algorithm is chosen, applying SBB algorithm to minimize the cost of energy usage as the result of scheduling the use of energy over consecutive time slots by the plurality of group components to effectively redistribute the time of use of energy leading to lowest cost energy strategy within said time interval (113);
disseminating the schedule of turn on and turn off to smart plugs (114); and
going back to step (103) to wait again for the expiration of said refresh timer.

In another integrated embodiment illustrated by FIG. 6, the present invention features a computer program product to to minimize the total cost of energy consumption of a given GEC either connected to or isolated from a power grid over a daily, weekly, or monthly time interval. The computer program product may comprise:
importing static information including time interval duration, schedule granularity, specifications of all group devices, per unit cost of energy charged by a utility operator operating said power grid either based on time of use or tier of use (101);
importing per component energy consumption information at least comprising usage power of energy consuming components within said time interval (102);
if present, importing per component energy generation information at least comprising per component energy storage capacity, and dynamic factors within said time interval affecting the rate of energy generation (102);
waiting for the expiration of a refresh timer at the beginning of said time interval (103);
importing dynamic forecast information hourly sun, cloud, temperature, wind, humidity, precipitation, UV index, and water pressure (104)
choosing a prediction algorithm (105) to predict stored energy (105);
if LLSR machine learning prediction algorithm is chosen, applying LLSR algorithm (106) to predict stored energy;
if ARIMA machine learning prediction algorithm is chosen, applying ARIMA algorithm (107) to predict stored energy;
if MLPDL prediction algorithm is chosen, applying MLPDL algorithm (108) to predict stored energy;
setting predicted stored energy made available for use during time interval (109);
applying optimization static inputs comprising imported time interval duration, schedule time granularity, component specifications, and dynamic inputs comprising predicted stored energy (110);
choosing an optimization algorithm (111);
if IPBB algorithm is chosen, applying IPBB algorithm to minimize the cost of energy usage as the result of scheduling the use of energy over consecutive time slots by the plurality of group components to effectively redistribute the time of use of energy leading to lowest cost energy strategy within said time interval (112);
if SBB algorithm is chosen, applying SBB algorithm to minimize the cost of energy usage as the result of scheduling the use of energy over consecutive time slots by the plurality of group components to effectively redistribute the time of use of energy leading to lowest cost energy strategy within said time interval (113);
disseminating the schedule of turn on and turn off to smart plugs (114); and
going back to step (103) to wait again for the expiration of said refresh timer.

In yet a further integrated embodiment illustrated by FIG. 6, the present invention features a system for minimizing the total cost of energy consumption of a of a given GEC either connected to or isolated from a power grid over a daily, weekly, or monthly time interval. The system may comprise a processor, and a memory coupled to the processor, the memory stores instructions readable by a computing device that, when executed by the processor, cause the processor to perform operations. The operations may comprise:
importing static information including time interval duration, schedule granularity, specifications of all group devices, per unit cost of energy charged by a utility operator operating said power grid either based on time of use or tier of use (101);
importing per component energy consumption information at least comprising usage power of energy consuming components within said time interval (102);
if present, importing per component energy generation information at least comprising per component energy storage capacity, and dynamic factors within said time interval affecting the rate of energy generation (102);
waiting for the expiration of a refresh timer at the beginning of said time interval (103);
importing dynamic forecast information hourly sun, cloud, temperature, wind, humidity, precipitation, UV index, and water pressure (104)
choosing a prediction algorithm (105) to predict stored energy (105);
if LLSR machine learning prediction algorithm is chosen, applying LLSR algorithm (106) to predict stored energy;
if ARIMA machine learning prediction algorithm is chosen, applying ARIMA algorithm (107) to predict stored energy;
if MLPDL prediction algorithm is chosen, applying MLPDL algorithm (108) to predict stored energy;
setting predicted stored energy made available for use during time interval (109);
applying optimization static inputs comprising imported time interval duration, schedule time granularity, component specifications, and dynamic inputs comprising predicted stored energy (110);
choosing an optimization algorithm (111);
if IPBB algorithm is chosen, applying IPBB algorithm to minimize the cost of energy usage as the result of scheduling the use of energy over consecutive time slots by the plurality of group components to effectively redistribute the time of use of energy leading to lowest cost energy strategy within said time interval (112);
if SBB algorithm is chosen, applying SBB algorithm to minimize the cost of energy usage as the result of scheduling the use of energy over consecutive time slots by the plurality of group components to effectively redistribute the time of use of energy leading to lowest cost energy strategy within said time interval (113);
disseminating the schedule of turn on and turn off to smart plugs (114); and
going back to step (103) to wait again for the expiration of said refresh timer.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 extracted from [11] shows a sample group of energy consuming, producing, and storing components in a residential setting.

FIG. 2 extracted from [12] shows a sample charging station in a commercial setting.

FIG. 3 illustrates a sample fixed, fully connected, feedforward perceptron MLPDL structure utilized for predicting the stored energy of a GEC within an interval of interest.

FIG. 4 shows the Simplex branch and bound algorithm.

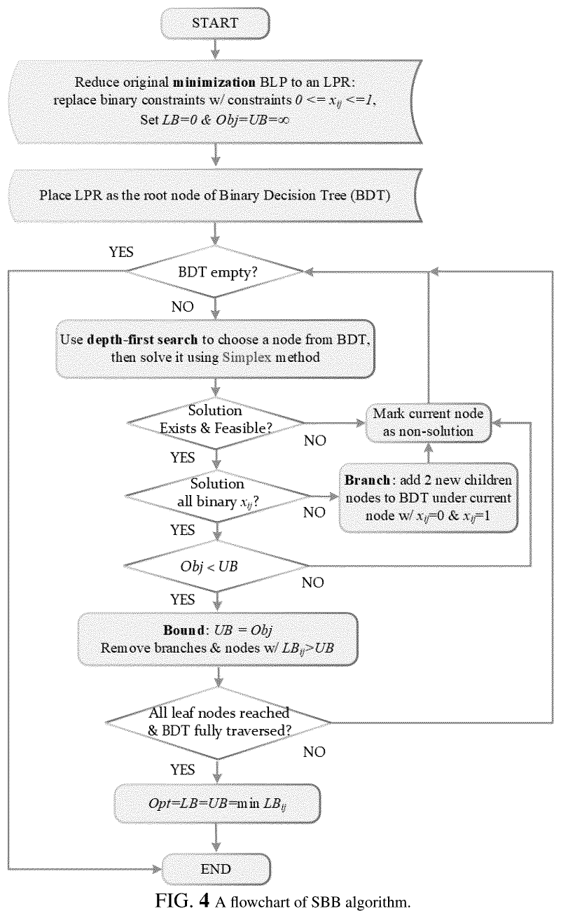

FIG. 5 illustrates the interior point branch and bound algorithm.

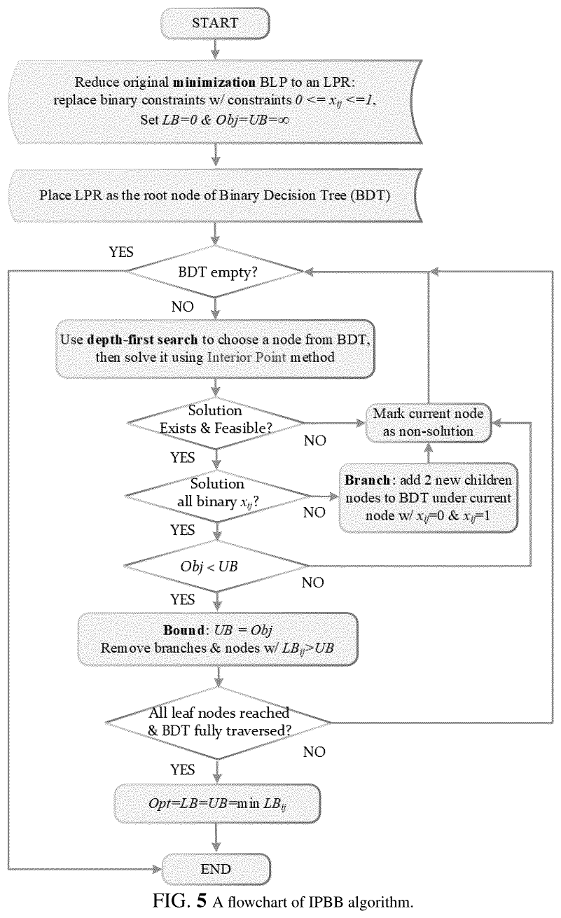

FIG. 6 shows an exemplary flowchart of the present invention.

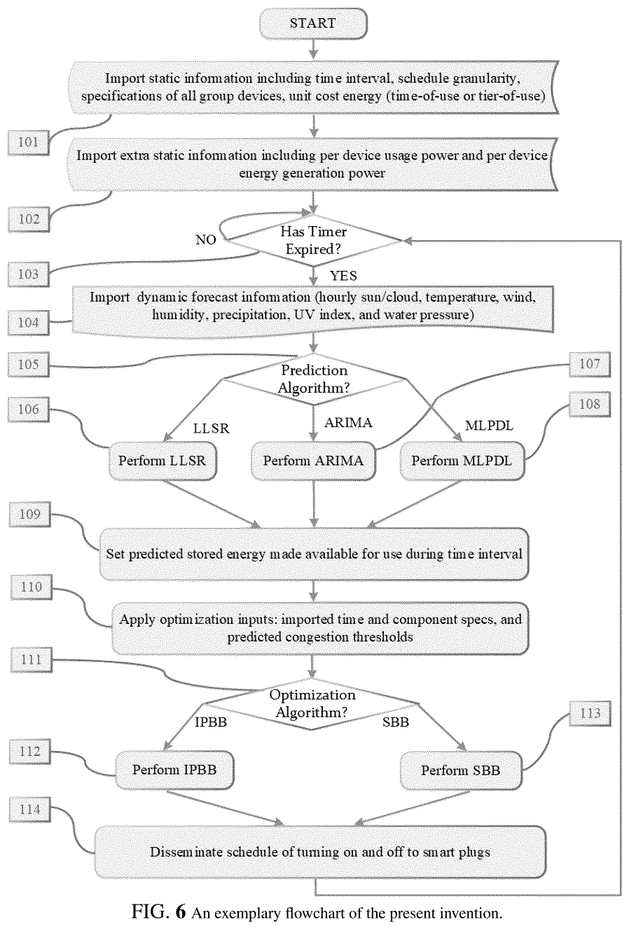

FIG. 7 illustrates a sample daily optimal schedule.

### DETAILED DESCRIPTION OF THE INVENTION

This invention focuses on systematically identifying an optimal schedule of energy consumption for a given GEC comprising a number of smart ON-OFF electrical smart plugs that feed energy consuming components within a commercial or residential unit. Optionally, the GEC may also comprise energy producing components capable of capturing solar, wind, hydropower, geothermal, and biomass renewable energy forms. Such components comprise solar panels, wind turbines, hydraulic turbines, steam turbines, generators along with supporting equipment and energy storing components such as batteries. First, one of the available learning schemes, namely, LLSR, ARIMA, or MLPDL predicts the energy produced, stored, and made available for use during a time interval of interest by the EPC. Next, an optimization problem aiming at identifying the optimal schedule of energy consumption of said group is formulated using hourly, half-hourly, or shorter periods as decision variables. The problem is then solved using one of the two algorithms chosen from several algorithms available within the literature of optimization theory, namely, SBB or IPBB. Accordingly, integrated method, program, and system sets aiming at minimizing the cost of energy consumption subject to energy storage capacity and component availability constraints are introduced.

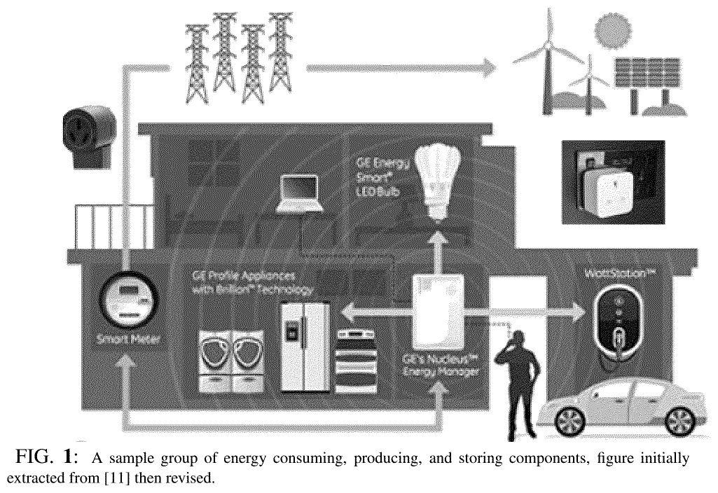

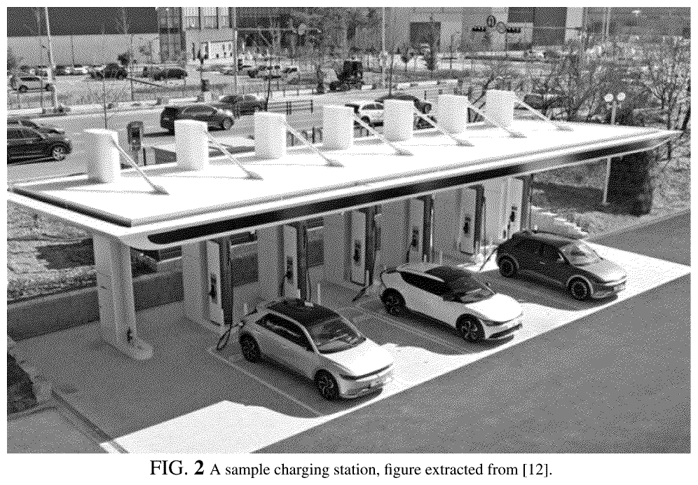

In an embodiment of the presented scheduling algorithms, a group of components illustrated in FIG. 1 are used. This embodiment represents a typical residential unit. In another embodiment of the presented scheduling algorithms, a group of components illustrated in FIG. 2 are used. This embodiment represents a typical commercial unit.

In some embodiment, the present invention presents a solution to minimize the cost of energy usage by first predicting the produced and stored energy of said residential or commercial GEC over a time interval of interest, e.g., a day. Utilizing the predicted stored energy as operational constraints, fine granular ON-OFF periods of usage within the time interval of interest, e.g., hourly, are identified in the form of an optimal schedule. Low complexity of the solutions allow them to be embedded into live systems making live decisions about energy consumption at the beginning of the periods of interest.

Table 1 provides a listing of notations used in this invention disclosure.

### Learning-Based Energy Storage Modeling

First, three approaches to learning energy produced by EPC of the group are discussed. For all 3 approaches, a critical factor in generating accurately predicted results is the choice of input dataset representing previous system production as well as weather forecast and measurements. In a number of embodiments, past system production measures, forecasts and

TABLE 1
Table of notations used in this invention disclosure.

| | |
|---|---|
| m | Number of time slots within interval of interest, e.g., daily hours |
| n | Number of devices |
| I | Set of time slots, i.e., I = {1, . . . , m} |
| i | Hour index set in I |
| J | Set of devices, i.e., J = {1, . . . , n} |
| j | Device index set in J |
| cᵢ | Grid cost of consuming energy within hour i |
| xᵢⱼ | Binary decision variable which is set to 1 if device j uses energy |
| | from grid within hour i |
| yᵢⱼ | Binary decision variable which is set to 1 if device j uses energy |
| | produced internally within hour i |
| P | The number of devices that can be simultaneously charged |
| kⱼ | Charging station hourly conversion factor for device j in KWH |
| eⱼ | The energy level needed by device j within daily charging period |
| E₀[d] | Predicted total energy level produced and stored internally by GEC |
| | within daily charging period |

actual weather measurements over several comparable past seasonal periods are used as input data.

### Linear Least Square Regression Machine Learning

In an embodiment, linear least squares regression is used to predict stored energy by EPC of the group within the interval of interest as a function of the current weather input data. In LLSR, the conditional mean of produced energy of EPC of the GEC is assumed to be an affine function of those values. Linear least square regression focuses on the conditional probability distribution of the average produced energy, rather than on the joint probability distribution of the produced energy. In this embodiment, the relationship between stored energy and the input data is modeled using linear predictor functions whose unknown model parameters are estimated from the forecast and collected data. In essence, LLSR is used to to fit a predictive linear model to the observed data set of the average number of weather data points (x-axis) and stored energy (y-axis). In LLSR, the relationship between the average number of input data and stored energy utilization is assumed to be linear and least squares is the method used to find the best fit line for the collected dataset. LLSR creates a straight line that minimizes the sum of squares of the errors generated from the differences in the observed values and the values predicted by the model. After developing the model, i.e., specifying the line, the value of a weighted function of input data is identified as the x-coordinate of the crossing point of the model line and the horizontal line corresponding to the value of stored energy.

### Auto Regressive Integrated Moving Average Machine Learning

In another embodiment, autoregressive integrated moving average is used to predict energy stored by EPC of the GEC within the interval of interest as a function of the current weather input data. ARIMA model is a generalization of an autoregressive moving average model in which measured and forecast weather data are fitted to predict future points in the series. ARIMA model is applied particularly because input data show evidence of non-stationarity but an initial differencing step corresponding to the integrated part of the model can be applied one or more times to eliminate non-stationarity.

The AR part of ARIMA indicates that the evolving variable of interest is regressed on its own lagged values. The MA part indicates that the regression error is actually a linear combination of error terms whose values occurred contemporaneously and at various times in the past. The I indicates that the data values have been replaced with the difference between their values and the previous values and that this differencing process may have been performed more than once. The purpose of each of these features is to make the model fit the data as well as possible. The ARIMA model used is then denoted as ARIMA(p, d, q) where parameters p, d, and q are non-negative integers, p is the order (number of time lags) of the autoregressive model, d is the degree of differencing (the number of times the data have had past values subtracted), and q is the order of the moving-average model. Experimentally speaking, setting the values of p, d, q in the range of [1, 3] yields reasonable results in predicting the values of energy stored by EPC of the GEC associated with current weather input data.

### Multi Layer Perceptron Deep Learning

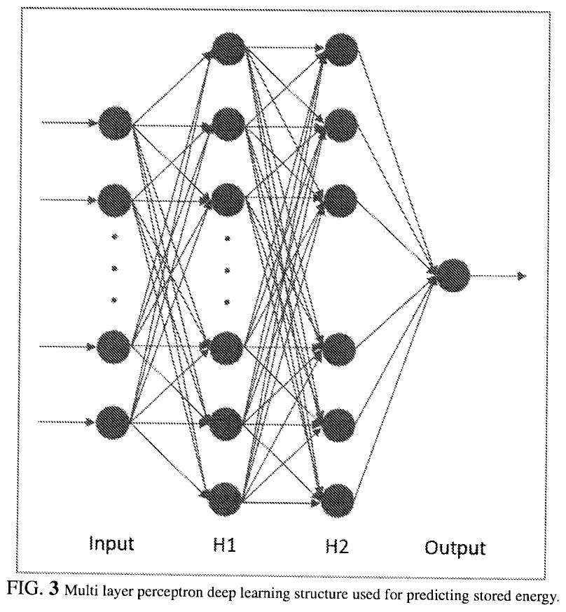

In yet another embodiment, MLPDL is used to predict the energy stored by EPC of the GEC within the interval of interest as a function of the current weather input data. In this embodiment, a fixed, fully connected, feedforward perceptron learning structure is utilized for the task of stored energy prediction. Such structure consists of an input layer with 7 to 10 processing elements to accept up to 10 input dataset measurements. In order to strike the balance between accuracy and complexity, the structure considers two hidden layers, each layer containing up to ten processing elements. The structure has an output layer with one processing element predicting the value of stored energy for the period of interest. FIG. 3 illustrates the MLPDL structure used for the task of learning.

In each iteration of learning, all inputs associated with a sample input are propagated in the forward direction from the input through hidden layers to generate an output. The output value is compared to the measured output and an output error is calculated. The output error is then propagated in the reverse direction to the input layer in order to adjust weighting functions between every pair of processing elements in adjacent layers. The process is repeated until reaching an acceptable threshold of output error. For evaluating the error, Root Mean Square Error (RMSE) is calculated between the measured stored energy and MLPL predicted stored energy from the collected data.

### Optimal Scheduling

In additional embodiments, predicted stored energy values, one per time interval of interest, are utilized in an optimization problem aiming to identify optimal schedules of energy usage within given intervals for all ECCs of the GEC. Solutions to the problems identify the ON-OFF schedules of the smart plugs, one per time interval of interest, feeding ECCs within the GEC. Such schedules are identified subject to the constraints of times of availability, energy required, and the total stored energy among others.

As a scheduling problem identifying periods of energy use drawn from the power grid and internally stored energy sources, the problem comprises two sets of binary decision variables per interval of interest. For an embodiment in which the interval of interest is daily and the granularity of schedule is hourly, the schedule identifies a total of 48 binary decision variables per ECC to cover the usage of energy drawn from the power grid and internally stored sources within 24 hours. For other embodiments comprising different durations and granularities, the number of decision variables is accordingly adjusted.

### Problem Description

The embodiment of interest attempts at identifying a schedule associated with the lowest cost of usage. The general considerations are as follows. First, it is preferred to use internally stored energy within the hours in which the power grid energy is most expensive. Stored energy is to be used for feeding ECC types such as TVs and other appliances whose use cannot be scheduled. Remaining stored energy can then be used for ECCs such as EVs, washing or drying appliances whose use can be scheduled. Second, stored energy pool is to be used at the maximum level possible before tapping into power grid energy sources. Third, the use of energy from the power grid is to be scheduled within the lowest cost hours as much as possible.

### Problem Formulation

In an embodiment of the invention, the formulated optimization problem is expressed as shown below.

$${min}_{\underline{x} , \underline{y}} {\sum }_{i ∈ I} {\sum }_{j ∈ J} {c}_{i} [ {x}_{ij} + {y}_{ij} ] \qquad ( 1 )$$

$$\begin{matrix}S . T . {\sum }_{j ∈ J} ( {x}_{ij} + {y}_{ij} ) \leq P , & ∀ i ∈ I\end{matrix} \qquad ( 2 )$$

$$\begin{matrix}{\sum }_{i ∈ I} {k}_{j} ( {x}_{ij} + {y}_{ij} ) \geq {e}_{j} , & ∀ j ∈ J\end{matrix} \qquad ( 3 )$$

$$\begin{matrix}{x}_{ij} = {y}_{ij} = 0 , & ∃ i ∈ I , ∃ j ∈ J\end{matrix} \qquad ( 4 )$$

$${\sum }_{i ∈ I} {\sum }_{j ∈ J} {k}_{j} {y}_{ij} \leq {E}_{0} [ d ] \qquad ( 5 )$$

$$Binary {x}_{ij} ∈ \{ 0 , 1 \} , {y}_{ij} ∈ \{ 0 , 1 \} , ∀ i ∈ I , ∀ j ∈ J \qquad ( 6 )$$

The formulation attempts at minimizing the cost of energy usage for the GEC identifying the ON-OFF schedule of the smart plugs per time interval of interest feeding ECCs within the GEC. The decision variables are identified by matrix X=[xᵢⱼ]_{m×n} associated with device j over time slot i on power grid and matrix Y=[yᵢⱼ]_{m×n} associated with device j over time slot i on energy internally stored within the GEC. In its most general from, the optimization problem is to be solved subject to five constraints some of which may be relaxed depending on the conditions a particular GEC. The objective function measures the cost of energy within the tie interval of interest with cᵢ showing the cost of energy for the unit of time during time slot i. Constraint 2 reflects the the limitation on the total number of charging stations for a given GEC, i.e., only P devices can be simultaneously charged in a given time slot. Constraint 3 captures the fact that every device j has to be charged to a minimum level of energy it requires denoted by eⱼ. Constraint 4 simply shows that not all devices are available for charging during all time slots. Constraint 5 expresses that the sum of energy used associated with variables yᵢⱼ cannot exceed the total energy E₀[d] captured by the GEC within the interval of interest. E₀[d] is predicted relying on one of the prediction techniques noted earlier. Finally, Constraint 5 shows that the optimization problem represents a Binary Linear Programming (BLP) problem in the embodiment above.

### Solution Approach

Considering the fact that the formulated problem is a BLP problem in which decision variables assume binary values, different solution embodiments have to solve an NP-complete problem. Generally speaking, BLP problems are solved using an approach in which an LP Relaxation (LPR) problem, i.e., a problem identical to the BLP problem without binary constraints are solved first. In the case of the formulated problem of this invention, LPR problem is the same as the problem of 1 with constraints 2-5. However, Constraint 6 is replaced by a pair of constraints shown below.

$$\begin{matrix}0 \leq {x}_{ij} \leq 1 , & ∀ i ∈ I , ∀ j ∈ J\end{matrix} \qquad ( 7 )$$

$$\begin{matrix}0 \leq {y}_{ij} \leq 1 , & ∀ i ∈ I , ∀ j ∈ J\end{matrix} \qquad ( 8 )$$

In two different embodiments, the LPR problem can be solved either using Simplex or IP methods [10]. Once the LPR problem is solved, one of several algorithmic alternatives available in the literature of optimization theory may be used to derive the binary solution from the initial solution of LPR problem. Considering its practical efficiency, Branch and Bound (BB) method is chosen for this purpose. BB is a combinatorial optimization method that can be used to solve BLPs. It involves forming a binary decision tree and then applying effective branching and bounding strategies to tighten the bounds of LPR problems.

Collectively, two algorithmic embodiments combining different permutations of solving LPR and identifying the solution to BLP from the solution to LPR are thus presented. The two embodiments are referred to as Simplex Branch and Bound (SBB) and Interior Point Branch and Bound (IPBB) methods. The building blocks of these embodiments are described next.

### Simplex

Consider an LP problem with η decision variables and μ constraints. The simplex method is an iterative solution approach in which a number of slack variables, one per constraint, are defined to turn inequality constraints to equality constraints. Utilizing a set of η+μ decision variables comprising the initial and slack decision variables, primal and dual dictionary solutions are found that satisfy all existing constraints. Every dictionary solution contains a partitioning of η+μ variables to basic and non-basic decision variables. Each iteration then pivots by swapping one of the basic decision variables with one of the non-basic decision variables in a way that the resulting dictionary solution is better than the previous dictionary solution. Multiple pivots are applied until the dictionary solution can no further be improved. This final solution is the optimal solution. Geometrically speaking, Simplex solution identifies the boundary of the feasible region of an LP problem and then starts from one of the vertices of the feasible region within the hyper-planes in the η+μ dimensional space formed by the intersection of individual constraints. Every pivot then moves the current solution from one vertex to another neighboring vertex until the optimal vertex is identified. Different variations of Simplex method such as self-dual parametric Simplex method [10] exist that deal with the issues of pivot degeneracy and offer improved speeds of convergence. With respect to convergence, it is noted that the average convergence speed of improved variations of simplex method are in the order of O(η+μ)³. See Chapters 1-5 of [10] for details of Simplex method and its complexity discussion.

### Interior Point

Inspired by the solution approaches to nonlinear optimization problems, the IP methods form a class of alternative iterative solution approaches for LPs. From among the IP family of problems, the path-following method is described in which a central path is formed staying on which the optimal solution can be reached. The path-following method replaces the constrained LP problem with a constrained NonLinear Programming (NLP) problem. In the NLP problem, the initial LP constraints remain in the form of equality constraints with slack variables but the objective function becomes a parametric logarithmic barrier function with parameter X. In essence, the objective function is the sum of the initial LP objective function and a number of logarithmic barrier terms each multiplied by λ, one associated with each initial and one associated with each slack variable. The path-following method is a one-phase method that begins from a point within the interior of the feasible region of an LP problem and will apply a number of iterative nonlinear optimization steps to eventually find the optimal solution. Every step consists of finding an appropriate value of λ smaller than its current value, computing step directions associated with vectors of primal, dual, primal slack, and dual slack variables on a so-called central path, computing an appropriate step length parameter to control the rate of change to the vectors of primal, dual, primal slack, and dual slack variables, and updating the vectors. Geometrically speaking, IP path-following solution applies a number of consecutive steps to an NLP with η+μ variables that iteratively result in getting closer to the optimal solution on the central path. Eventually, the optimal solution is identified as the value of λ approaches zero. Different variations of IP method exist that may use different nonlinear objective function but they all start from an interior point of the feasible region and through a number of iterative steps arrive at the optimal solution. With respect to convergence, it is noted that the average convergence speed of the path-following method is in the order of O(log(η+μ)×ƒ(λ)). The function ƒ(λ) captures the complexity of completing a single iterative step typically utilizing first and second order optimality KKT conditions.

See [10] Chapters 17-19 for details of Interior Point method and its complexity discussion.

### Branch and Bound

As noted previously, BB is a combinatorial optimization method that can be used to solve BLPs. It involves forming binary decision trees and optionally applying cutting planes in order to tighten the bounds of LPR problems. Applying BB translates to solving a potentially large number of related LP problems in searching for the optimal solution to a BLP problem. BB starts by solving LPR problem derived after replacing all binary constraints of the original problem with constraints forcing decision variables to assume values in the continuous range of [0,1] inclusive of boundary points. After an optimal solution to LPR problem is obtained and assuming this solution has a non-binary value for a decision variable that is supposed to be binary, the problem is split into two versions by adding a new constraint associated with setting one of the non-binary variables to either zero or one. The newly derived LP problems are solved and the process repeats iteratively forming a binary decision tree. During the BB process, non-binary solutions to LP problems serve as upper bounds and binary solutions serve as lower bounds to the optimal solution. A node in the decision tree can be pruned if its upper bound is lower than an existing lower bound. The optimal solution is derived once all branches of the decision tree have either been pruned or reached their leaf nodes.

When it comes to choosing branching strategy, one could either systematically solve all the problems on a given level of the tree before going deeper, i.e., perform breadth-first search, or go deep to leaf nodes of the tree before going wide, i.e., perform a depth-first search. There are three reasons why depth-first search is generally the preferred branching strategy. The first reason is the simplicity of numerical implementation. The second reason reason is based on the observation that as one moves deeper in the decision tree, each subsequent LP problem is obtained from the preceding problem by simply adding an upper or lower bound on one specific variable. The third reason is based on the observation that most binary solutions lie deep in the tree and there are two advantages to finding binary feasible solutions early. Not only it is better to have a feasible solution than nothing in case the search process ends early, but there may be significant tree pruning opportunities and efficiency gains as the result of observing the optimal objective function associated with one node is lower than the best-so-far binary solution.

With respect to convergence, it is noted that the worst case complexity of binary search is exponential. In practice, proper use of pruning techniques combined with sophisticated branching strategies significantly bring down the average complexity of the algorithm allowing to solve BLPs with a large number of decision variables in relatively short periods of time. Some of the more complex branching strategies include applying strong branching early and switching to pseudo cost branching at a later stage.

See [10] Chapter 22 and references within for details branch and bound algorithms and its extensions.

### An Example Embodiment

In an example embodiment illustrated by FIG. 2, a small commercial delivery business located within a residential area requires to identify the optimal schedule of charging of its 4 EVs, namely one of each vehicles of type Tesla 3, Tesla X, Tesla Y, and Tesla S on a daily basis. Each EV is to be driven 200 miles per day and is made available for charging when not in operation. The hours of operation are from 11:00 am to 6:00 pm. The local utility company charges according to a TOU usage rate schedule shown in Table 2. In addition, the daily energy charging requirements of the 4 EVs are shown in Table 3.

TABLE 2
Sample utility TOU hourly rates

| TOU Tier | Hours | Hourly Rate |
|---|---|---|
| Super off peak | [8:00pm, 8:00am] | $0.25 |
| Off peak | [8:00am, 5:00pm] | $0.32 |
| Mid peak | [5:00pm, 8:00pm] | $0.48 |

TABLE 3
EV charging requirements.

| Vehicle Type | Usage Rate | Distance | Energy Need |
|---|---|---|---|
| Tesla 3 | 0.34 KWH/mile | 200 miles/day | 78 KWH |
| Tesla X | 0.34 KWH/mile | 100 miles/day] | 34 KWH |
| Tesla Y | 0.26 KWH/mile | 200 miles/day] | 52 KWH |
| Tesla S | 0.27 KWH/mile | 100 miles/day] | 27 KWH |

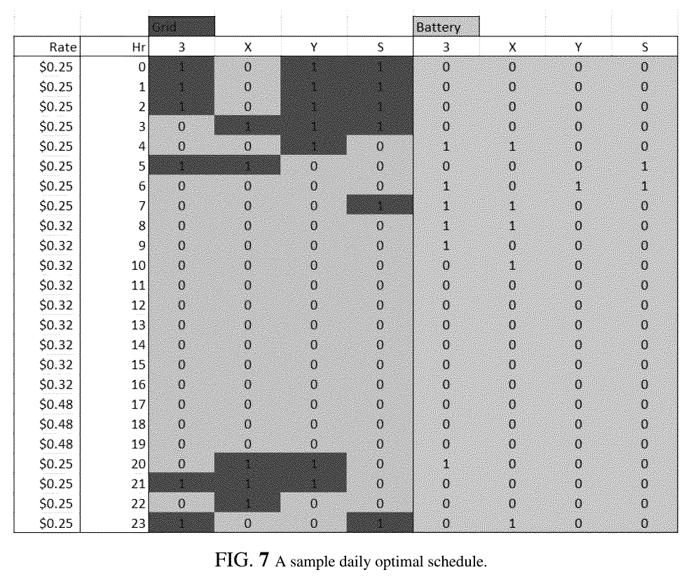

Each EV is required to be fully charged at the beginning of each day. Further, a total of 3 charging stations are assumed to be available each with specifications of 220 V and 32 Amps. The business is connected to the grid and is also equipped with a solar and battery storage system with a maximum battery storage capacity of 120 Kilo Watt Hours (KWH). On a given day, the MLPDL predicts an energy production and storage of 99 KWH. The optimal schedule of charging that minimizes the cost of charging for the given day after solving the optimization problem with the objective function (1) and constraint (2) through constraint (6) is given in FIG. 7. The schedule uses the full charge capacity of its batteries and requires the use of 24 KWH of energy from the grid associated with a minimum daily cost of $6.00 charged by the utility company.

### A Sample Statistical Experimentation Embodiment

In another embodiment, the example embodiment above is used to form a statistical measurement comprising 10,000 experiments. In each experiment, the daily energy production and storage of the system as predicted by the MLPDL is passed a pair of schedulers. Then, a scheduler produces daily schedule once a day. While the first scheduler follows SBB to create daily schedules, the second scheduler follows a randomized schedule weighted based on hourly cost of energy and constrained based on the number of available charging stations. Both schedulers fully utilize the stored energy of the system before using energy from the grid. The results reveal that the cost of optimal scheduler is $60,570 where as the cost of randomized scheduler is $73,200 both measured over a period of 10,000 days.

It is noted that the runtime of the randomized scheduler is much lower than that of the optimal scheduler. However, per iteration runtime of the optimal scheduler using either SBB or IPBB does not exceed 4 milliseconds on a computing host with an Intel i7 generation 8 CPU and 32 GB of memory. Equivalently, the total runtime of the statistical experiment for 10,000 runs remains under 40 seconds. Finally, it is noted that the energy cost difference of SBB and IPBB variants of the optimal scheduler do not exceed 1%.

### Alterations, Modifications, and Clarifications

Many alterations and modifications may be made by those having ordinary skills in the art without departing from the spirit and scope of the invention. Therefore, it must be understood that the illustrated embodiment has been set forth only for the purposes of example and that it should not be taken as limiting the invention as defined by its various embodiments and the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

In some embodiments described herein using the phrase “comprising” includes embodiments that could be described as “consisting of”, and as such the written description requirement for claiming one or more embodiments of the present invention using the phrase “consisting of” is met.

Reference numbers cited in the claims are exemplary, for ease of review by the patent office only, and are not limiting in any way.

Figures are representatives of concepts only and the claims are not limited by the figures in any ways.

### PATENT CITATIONS

[1]U.S. Ser. No. 11/210,747 Systems and methods for randomized, packet-based power management of conditionally-controlled loads and bi-directional distributed energy storage systems.
[2]U.S. Ser. No. 11/150,618 Packetized energy management control systems and methods of using the same.
[3] US20190214820 Systems and methods for random-access power management.
[4] US20180189899 Using loads with discrete finitie states of power to provide ancillary services for power grid.
[5] US20170104332 Energy storage controller with battery life model.
[6] US20160261116 Low-frequency ancillary power grid services.
[7] WO2019108891A1 Methods and systems for secure scheduling and dispatching synthetic regulation reserve from distributed energy resources.
[8] CN110416998B Regional complex distribution network scheduling control management system based on virtual power plant.
[9]U.S. Ser. No. 11/095,127 Method for real-time scheduling of multi-energy complementary micro-grids based on rollout algorithm.

### NON-PATENT CITATIONS

[10]R. J. Vanderbei, “Linear Programming: Foundations and Extensions, Fifth Edition” Springer, 2020.
[11]S. K. Korkua, K. Thinsurat, “A Load Prioritization Model for a Smart Demand Responsive Energy Management System in the Residential Sector,” Walailak Journal, August 2013.
[12]K. Da-Sol, “Race for EV charging stations intensifies for market dominance,” Available at URL http://www.koreaherald.com/view.php?ud=20211130000633, Korea Herald, Nov. 30, 2021.

1. A method of minimizing the total cost of energy consumption of a group of devices connected to a power grid over a daily, weekly, or monthly time interval wherein said group of devices comprises one or more remotely controlled smart plugs, one or more energy consuming components plugged to smart plugs, and zero or more components capable of producing and storing renewable forms of energy and wherein the method comprises:
a. importing per unit cost of energy charged by a utility operator operating said power grid either based on time of use or tier of use;
b. importing per component energy consumption information at least comprising usage power of energy consuming components within said time interval;
c. if present, importing per component energy generation information at least comprising per component energy storage capacity, and dynamic factors within said time interval affecting the rate of energy generation;
d. choosing a prediction algorithm;
e. choosing an optimization algorithm;
f. waiting for the expiration of a refresh timer at the beginning of said time interval;
g. importing additionally collected periodical measurements of energy components of step b and step c since the previous expiration of the refresh timer of step f;
h. applying the algorithm chosen in step d to predict energy stored during said time interval by the plurality of energy storing components of the group;
i. adjusting maximum energy made available for consumption to said group produced by energy generating components of the group within said time interval based on the variations of the imported information of step b and step c;
j. setting optimization inputs comprising imported information of step b, step c, and predicted energy storage of step h;
k. applying the optimization algorithm chosen in step e to minimize the cost of energy usage as the result of scheduling the use of energy over consecutive time slots by the plurality of group components to effectively redistribute the time of use of energy leading to lowest cost energy strategy within said time interval;
l. collecting the schedule of energy usage generated by the optimization algorithm in step k;
m. utilizing existing network to signal smart plugs at the beginning of every time slot within said time interval to turn on or turn off according to energy usage schedule of step l; and
n. going back to step c to wait again for the expiration of said refresh timer.

2. The method of claim 1, wherein the length of scheduling time slots can vary to include hourly, half-hourly, quarter-hourly, and shorter intervals at every granularity of minutes.

3. The method of claim 1, wherein energy producing components capable of capturing solar, wind, hydropower, geothermal, and biomass renewable energy forms comprise solar panels, wind turbines, hydraulic turbines, steam turbines, generators along with supporting equipment and energy storing components comprise batteries.

4. The method of claim 1, wherein the dynamic factors of step c comprise hourly weather forecast information during said time interval including sun, cloud, temperature, wind, humidity, precipitation, UV index, and water pressure among other factors.

5. The method of claim 1, wherein the choice of prediction algorithm of step c comprises Multi-Layer Perceptron Deep Learning (MLPDL), Auto Regressive Integrated Moving Average (ARIMA) machine learning, and Linear Least Square Regression (LLSR) machine learning techniques.

6. The method of claim 1, wherein the choice of optimization algorithm of step d comprises the Simplex Branch and Bound (SBB) and Interior Point Branch and Bound (IPBB) algorithms.

7. A computer program product stored in a non-transitory computer readable storage medium to minimize the total cost of energy consumption of a group of devices connected to a power grid over a daily, weekly, or monthly time interval wherein said group of devices comprises one or more remotely controlled smart plugs, one or more energy consuming components plugged to smart plugs, and zero or more components capable of producing and storing renewable forms of energy and wherein the computer program product comprises:
a. importing per unit cost of energy charged by a utility operator operating said power grid either based on time of use or tier of use;
b. importing per component energy consumption information at least comprising usage power of energy consuming components within said time interval;
c. if present, importing per component energy generation information at least comprising per component energy storage capacity, and dynamic factors within said time interval affecting the rate of energy generation;
d. choosing a prediction algorithm;
e. choosing an optimization algorithm;
f. waiting for the expiration of a refresh timer at the beginning of said time interval;
g. importing additionally collected periodical measurements of energy components of step b and step c since the previous expiration of the refresh timer of step f;
h. applying the algorithm chosen in step d to predict energy stored during said time interval by the plurality of energy storing components of the group;
i. adjusting maximum energy made available for consumption to said group produced by energy generating components of the group within said time interval based on the variations of the imported information of step b and step c;
j. setting optimization inputs comprising imported information of step b, step c, and predicted energy storage of step h;
k. applying the optimization algorithm chosen in step e to minimize the cost of energy usage as the result of scheduling the use of energy over consecutive time slots by the plurality of group components to effectively redistribute the time of use of energy leading to lowest cost energy strategy within said time interval;
l. collecting the schedule of energy usage generated by the optimization algorithm in step k;
m. utilizing existing network to signal smart plugs at the beginning of every time slot within said time interval to turn on or turn off according to energy usage schedule of step l; and
n. going back to step c to wait again for the expiration of said refresh timer.

8. The computer program product of claim 7, wherein the length of scheduling time slots can vary to include hourly, half-hourly, quarter-hourly, and shorter intervals at every granularity of minutes.

9. The computer program product of claim 7, wherein energy producing components capable of capturing solar, wind, hydropower, geothermal, and biomass renewable energy forms comprise solar panels, wind turbines, hydraulic turbines, steam turbines, generators along with supporting equipment and energy storing components comprise batteries.

10. The computer program product of claim 7, wherein the dynamic factors of step c comprise hourly weather forecast information during said time interval including sun, cloud, temperature, wind, humidity, precipitation, UV index, and water pressure among other factors.

11. The computer program product of claim 7, wherein the choice of prediction algorithm of step c comprises Multi-Layer Perceptron Deep Learning (MLPDL), Auto Regressive Integrated Moving Average (ARIMA) machine learning, and Linear Least Square Regression (LLSR) machine learning techniques.

12. The computer program product of claim 7, wherein the choice of optimization algorithm of step d comprises the Simplex Branch and Bound (SBB) and Interior Point Branch and Bound (IPBB) algorithms.

13. A system comprising processors and memory coupled to processors, the memory storing instructions readable by a computing device that, when executed by processors, cause processors to perform operations to minimize the total cost of energy consumption of a group of devices connected to a power grid over a daily, weekly, or monthly time interval wherein said group of devices comprises one or more remotely controlled smart plugs, one or more energy consuming components plugged to smart plugs, and zero or more components capable of producing and storing renewable forms of energy and wherein the system comprises:
a. importing per unit cost of energy charged by a utility operator operating said power grid either based on time of use or tier of use;
b. importing per component energy consumption information at least comprising usage power of energy consuming components within said time interval;
c. if present, importing per component energy generation information at least comprising per component energy storage capacity, and dynamic factors within said time interval affecting the rate of energy generation;
d. choosing a prediction algorithm;
e. choosing an optimization algorithm;
f. waiting for the expiration of a refresh timer at the beginning of said time interval;
g. importing additionally collected periodical measurements of energy components of step b and step c since the previous expiration of the refresh timer of step f;
h. applying the algorithm chosen in step d to predict energy stored during said time interval by the plurality of energy storing components of the group;
i. adjusting maximum energy made available for consumption to said group produced by energy generating components of the group within said time interval based on the variations of the imported information of step b and step c;
j. setting optimization inputs comprising imported information of step b, step c, and predicted energy storage of step h;
k. applying the optimization algorithm chosen in step e to minimize the cost of energy usage as the result of scheduling the use of energy over consecutive time slots by the plurality of group components to effectively redistribute the time of use of energy leading to lowest cost energy strategy within said time interval;
l. collecting the schedule of energy usage generated by the optimization algorithm in step k;
m. utilizing existing network to signal smart plugs at the beginning of every time slot within said time interval to turn on or turn off according to energy usage schedule of step l; and
n. going back to step c to wait again for the expiration of said refresh timer.

14. The system of claim 13, wherein the length of scheduling time slots can vary to include hourly, half-hourly, quarter-hourly, and shorter intervals at every granularity of minutes.

15. The system of claim 13, wherein energy producing components capable of capturing solar, wind, hydropower, geothermal, and biomass renewable energy forms comprise solar panels, wind turbines, hydraulic turbines, steam turbines, generators along with supporting equipment and energy storing components comprise batteries.

16. The system of claim 13, wherein the dynamic factors of step c comprise hourly weather forecast information during said time interval including sun, cloud, temperature, wind, humidity, precipitation, UV index, and water pressure among other factors.

17. The system of claim 13, wherein the choice of prediction algorithm of step c comprises Multi-Layer Perceptron Deep Learning (MLPDL), Auto Regressive Integrated Moving Average (ARIMA) machine learning, and Linear Least Square Regression (LLSR) machine learning techniques.

18. The system of claim 13, wherein the choice of optimization algorithm of step d comprises the Simplex Branch and Bound (SBB) and Interior Point Branch and Bound (IPBB) algorithms.
